(19) United States
(12) Patent Application Publication
(10) Pub. No.: US 2009/0029326 A1
(43) Pub. Date: Jan. 29, 2009

(54) Integrated method of teaching cooking and reinforcing cooking skills

(76) Inventors: Shellie A. Kark, Denver, CO (US); Jon Kevin Higgins, Denver, CO (US)

Correspondence Address: A LAW FIRM, P.C., 8753 YATES DRIVE, SUITE 215, WESTMINSTER, CO, 80031, US

(21) Appl. No.: 11/828,184

(22) Filed: Jul. 25, 2007

(51) Int. Cl. G09B 19/00

(52) U.S. Cl. 434/127

(57) ABSTRACT

Disclosed is a system and method that can enable a user to understand the basis of one or more methods of food preparation through a learning construct that incorporates a teaching of foundational components with a teaching of a foundational process. The disclosed device also comprises a construct that can reinforce and/or strengthen the user's learned basis of understanding of components and processes beyond recipe replication. The reinforcement construct seeks to further instill the understanding of the technique being taught through a variety of tools, such as by the use of recipes, tables arranging possible ingredients, guides, charts, definitions, instructions, tips, pairings, etc.

### FIELD OF ART

The disclosed device relates generally to a system of educating a user in principles of cooking and more specifically to a system that integrates a basis of learning and understanding cooking techniques and a reinforcement of that basis of understanding that builds a user's ability and confidence in the cooking techniques with tools for adapting the cooking techniques so the user may prepare and create food dishes as desired.

### BACKGROUND

Cooking is the act of preparing food. The term “cooking” encompasses all methods of food preparation including heated and non-heated methods. It also encompasses a vast range of such methods, tools, and combinations of ingredients that alter the flavor and/or digestibility of food. Cooking can be defined as the process of selecting, measuring and combining ingredients in an ordered procedure in an effort to achieve a desired result. Factors that can typically affect the final outcome include the variability of ingredients, ambient conditions/surrounding environment, tools, and the skill of the individual who is cooking, or in other words, preparing the food.

While it can be said that some individuals may be trained in the art of molecular gastronomy, a discipline concerned with the application of scientific knowledge to cooking and gastronomy, the average person or “cook” may not truly even have an understanding of cooking at all. The average person may follow some or all of a recipe in an attempt to prepare food. However, a recipe typically guides one on how to prepare a dish. A recipe does not generally form any basis of understanding of how and/or why the ingredients are compiled in such a way and why that works. Thus, while recipes can be useful, recipes do not teach cooking as encompassed by the term. In fact, a person may follow numerous recipes to prepare a corresponding number of dishes and not truly understand cooking.

The disclosed device provides for a system and method that can be used to teach a user about the preparation of food. The disclosed device comprises tutorials on various methods of food preparation, suggested tools to be used, and combinations of ingredients that can be used to alter the flavor or digestibility of the preparable dish. Since the skill of the individual who is cooking can be a large factor that affects the resulting dish, the disclosed device seeks to increase the individual's ability and/or confidence so the individual may vary ingredients, ambient conditions and/or surrounding environment, and/or tools to achieve the result desired.

### SUMMARY OF THE DISCLOSURE

The disclosed device comprises a system and method that can enable a user to understand the basis of one or more methods of food preparation through a learning construct that incorporates a teaching of foundational components with a teaching of a foundational process. The disclosed device also comprises a construct that can reinforce and/or strengthen the user's learned basis of understanding of components and processes beyond recipe replication. The reinforcement construct seeks to further instill the understanding of the technique being taught and thus further develop cooking capabilities. The reinforcement construct may comprise recipes craftable specifically to reinforce the training a user receives when learning a specific cooking technique. As stated above, cooking is the act of preparing food. Thus, the term “cooking technique” can comprise all methods of food preparation, including preparation techniques.

The disclosed device may further comprise tables that are craftable in arranging ingredients that are known in the art by, e.g., seasoned chefs, to work well together. This portion of the construct could again be utilized to communicate the teaching of foundational components with the teaching of a foundational process.

A user may also learn about the selection of tools or equipment to be used, and combinations of ingredients that can be drawn on to alter the flavor or digestibility of the final outcome—a prepared dish. A user may thus learn to select and pair beverages, including wine, relative to the technique covered. The disclosed device may further comprise a reference component that can provides tables, guides, charts, definitions, instructions, tips, recipes, pairings, etc. that enable a user to further understand the technique covered, and thus continue to explore and/or develop cooking capabilities during the course of food preparation. These and other tools, combinations and/or subcombinations could serve to communicate and reinforce the teaching of foundational components and processes as taught by the disclosed system and method.

Although the disclosed device contemplates the use of digital video (or versatile) disc (DVD) as a storage media, other forms of data storage could be employed and/or used to deliver the content. Those having skill in the art will recognize that the amount and type of data to be stored will be considered in choosing an appropriate medium. In addition, the disclosed system can be combined with interactive functionality, i.e., touch screen monitors, touch screen monitors mountable in appliances, televisions, media players, etc. and may be used in an in-home, in-studio or other suitable environment. Devices having speech recognition could also be incorporated to provide a user with full use of their hands and faculties during the act of cooking. Those having skill in the art will recognize that a combination and/or variation of one or more types of data management, e.g., DVD combined with voice control, DVD combined with touch screen, etc. could be used and still fall within the spirit and scope of the disclosed system and method.

These and other advantages of the disclosed device will appear from the following description and/or appended claims, reference being made to the accompanying drawings that form a part of this specification wherein like reference characters designate corresponding parts in the several views.

### BRIEF DESCRIPTION OF THE FIGURES

FIG. 1 is an example of the main menu listing of one embodiment of the disclosed educational tool in the form of a DVD.

FIG. 2A is an example of one embodiment of a table displaying well-matched ingredients suggested for a pairing with beef as a key/main ingredient.

FIG. 2B is an example of the table embodiment of FIG. 2A displaying well-matched ingredients suggested for incorporating beef as a key/main ingredient with a French-styled sauté.

FIG. 2C is an example of the table embodiment of FIG. 2A displaying well-matched ingredients suggested for incorporating beef as a key/main ingredient with an Asian-styled sauté.

FIG. 3 is an example of one embodiment of a table displaying suggested hearty herbs, delicate herbs, and spices that may be chosen as a well-matched ingredient with the beef embodiment of FIG. 2A.

FIG. 4 is an example of one embodiment of a table displaying suggested beverages that could be paired with a beef embodiment.

FIG. 5 is an example of one embodiment of a table displaying knife selection factors.

Before explaining the embodiments of the disclosed device in detail, it is to be understood that the device is not limited in its application to the details of the particular arrangements shown, since the device is capable of other embodiments. Also, the terminology used herein is for the purpose of description and not of limitation.

### DESCRIPTION OF THE DISCLOSED DEVICE

The following description is provided to enable any person skilled in the art to make and use the disclosed apparatus. Various modifications, however, will remain readily apparent to those skilled in the art, since the generic principles of the present apparatus have been defined herein specifically to provide for an integrated system for the learning and understanding of fundamental cooking skills and processes.

The disclosed device provides for a system and method that can be used to teach a user about various cooking techniques and/or the preparation of food. Because the disclosed device can comprise tutorials that employ a visual, auditory, kinesthetic learning approach, or any combination or subcombination thereof, the learning process can be enhanced by the implementation of multiple learning techniques. A user can be introduced to the various concepts of cooking in an ordered procedure—or “step by step”. The suggested tools, equipment, and/or combinations of ingredients that can be used by the user are introduced “piece by piece”. With the disclosed device, the user can follow the various tutorials to learn transferable skills via a technique-based, interactive method that builds a foundation of cooking education.

As stated above, the disclosed device contemplates the use of DVD as an appropriate storage media. However, other forms of data storage could be employed. It is also contemplated that the disclosed device could incorporate one or more tutorials to interactively learn and understand cooking. As an example, the disclosed device could comprise a set of three instructional DVDs. A set could comprise any number of embodiments or volumes as suitable and still fall within the scope and spirit of the disclosure. In addition, a library could comprise a multiplicity of embodiments or volumes. A library embodiment could comprise, for example, one, two, three, etc. volumes, wherein each volume presents a different cooking technique. To illustrate the versatility of the disclosed system and method, one library embodiment could comprise one or more combinations or subcombinations of a series of different cooking lessons, e.g., Sautés & Pan Sauces, Soups & Stocks, Roasting, Knife Techniques, Grilling, Flavor Infusion: Marinades & Rubs, Braising, Short Doughs: Sweet & Savory Pastries. These titles are examples and are not determinative.

The disclosed device comprises a system and method that can enable a user to understand the basis of one or more cooking techniques by using a teaching approach that incorporates training of a user in foundational components and processes. A training of foundational components and the process by which the components are rendered provide for an understanding of a cooking technique and a user's ability to prepare a desired food/dish. While there are various techniques that make up the field of cooking, the disclosed device uses a common multiple component and multiple step integrated tool to present the concepts and knowledge useful for beginning a foundation in cooking.

The disclosed system teaches a multiple piece ensemble of components that are typically used in a cooking technique to formulate the basis of that cooking technique. To illustrate the technique, a user could advance through the typical steps of the cooking technique to realize a completed product. Although it can be helpful that the disclosed system utilizes a visual depiction of an instructor as a tool to guide the user through a training recipe in a side-by-side fashion with the user, any suitable teaching technique could also be employed.

The disclosed system thus presents the training by way of teaching concepts and/or steps useful for beginning a foundation in the chosen cooking technique. A variety of tools, some of which are discussed below as examples, can be used to present the foundational material. However, it should be recognized that the variety of type, category, style, and/or level, etc. of tools used to present foundational material can themselves vary in subject, application, tips, methods, etc. and is not limited to those presented herein.

To instill the knowledge transferred to the user of the chosen cooking technique for which the foundation has been laid, the disclosed system and method comprises one or more methods of reinforcing the foundational matter. One method of reinforcing the foundational knowledge can stem from a user's following of one or more recipes crafted to reinforce the principles taught. Another method of reinforcement lies with the use of information that is craftable into an arrangement of items that could be referred to as “well-matched”. The reinforcement tools can communicate the teaching of foundational components and process and thus strengthen a user's ability to prepare a desired food/dish.

Those having skill in the art will recognize that any suitable cooking technique could be taught and fall within the spirit and scope of the disclosed system and method.

In a sauté volume, the disclosed device seeks to instill in a user the process of the sauté technique by using a training recipe and reinforcing that process through other recipes. Other references such as tables, guides, charts, definitions, instructions, tips, recipes, pairings could be included to reinforce the foundational material. The disclosed device can thereby help to instill skills, confidence, and abilities that enable the user to cook and apply the technique without having to rely on a recipe. It can be said that the disclosed system and method seeks to empower the user with cooking knowledge. Under the current state of the art, this approach arguably differs from other approaches that simply teach how to replicate a recipe versus teaching the process so a user can make any number of recipes.

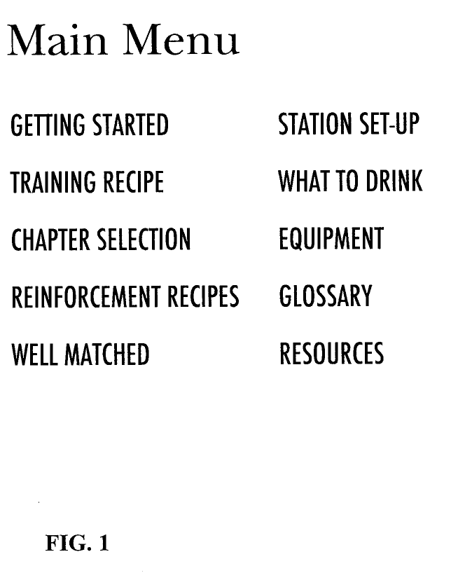

As shown in FIG. 1, the disclosed device can identify a variety of menu listings related to an educational DVD. In this example, a user can choose to view section headings entitled: Getting Started, Training Recipe, Chapter Selection, Reinforcement Recipe, Well Matched, Station Set Up, What to Drink, Equipment, Glossary, Resources. These section headings comprise topics that can be discussed in conjunction with the disclosed teachings and are shown by way of example and not of limitation as other section headings may be suitable. In addition, these headings are also possible in conjunction with, or independently from, one another. For example, a Getting Started section could describe for the user the arrangement of information on the DVD to orient the user for use. It could center on a particular cooking technique, provide the layout, and discuss the advantages of the disclosed system and method. For example, in a suitable embodiment, the concept of sauté as a quick cooking method could be explained.

Similarly, a “Station Set Up” section, a training recipe section, and/or any other suitable section could define for a user certain items that will generally remain invariable and are needed for any given dish regardless of the technique being learned. For example, it may discuss the concept of having all the ingredients to be used in a cleaned, cut, and otherwise prepared state—or mise en place—to accommodate the featured cooking technique. While a molecular gastronomist may easily understand the concepts behind for example, mise en place (to put in place), with the disclosed device the average user can become familiarized with such terms of art and concepts to achieve a better understanding of cooking and learn transferable skills. A “Station Set-Up” or other similar “set up” section could describe equipment used for a particular technique and ingredients used for a particular dish. These sections could vary in length and/or content depending on the technique being taught.

In one embodiment, a “Station Set Up” section provides professional “secrets” that could guide the user through the steps of maintaining the ingredients and equipment to be used to accommodate the featured cooking technique in an organized manner. Thus, in some cases, a “Station Set-Up” section could simply provide professional secrets to help ease the cooking process for things that generally are invariable. In some cases, an embodiment could provide not only professional secrets, but describe how and where in the DVD other education pertaining to equipment, terminology, wine education, regional cooking guidelines, spice and/or herb information, chef tips, etc. can be accessed. Those having skill in the art will recognize that a variety of interest areas in one or more “Station Set-Up” sections, or any other sections for that matter, could be taught and fall within the spirit and scope of the disclosed system and method.

The disclosed system teaches a multi-piece ensemble integrated with a multi-step process to define and teach a cooking technique. In a section titled “Training Recipe” of the sauté embodiment, components comprising a key/main ingredient, one or more accompaniment(s), a deglazing liquid, a broth, and one or more finishing ingredients are introduced as a basis of learning the foundational material. To illustrate the cooking technique, a training recipe can also be used to explain the foundational components and process, i.e., the foundational material, to establish a user's understanding of the cooking technique and his/her ability to prepare a food/dish. With the flexibility of DVD, the lesson can be taught in real time, wherein a user can virtually work alongside an instructor/chef to learn the technique. If desired, the disclosed device guides the user through the steps of the training recipe in a side-by-side fashion.

By defining the terms and explaining the rationale behind their inclusion and functionality, the disclosed device provides a user with a basis of understanding a particular cooking technique. A user can incorporate the multi-piece ensemble with the typical steps of the cooking technique to realize a completed product. In some cases, a user may determine from a reinforcement recipe that one or more of the ensemble components may not be necessary, however, with the multi-piece/multi-step system and method of teaching, a user will be able to accommodate any real and/or perceived variations from the foundational material and utilize flexibility with ability and confidence.

In conjunction with the teaching of a multi-piece ensemble of components, the disclosed system comprises a step by step methodology to learning a cooking technique. To illustrate the technique, a user thus advances through the typical steps of the cooking technique to realize a completed product. With the sauté technique, a six-step methodology can be used. However, each technique may be different. For example, a five-step methodology may be utilized for training on soups and a four-step methodology may be useful to teach how to make and prepare stocks. The disclosed system contemplates any number of suitable combinations of multi-component/multi-step arrangements in its integrated method of teaching cooking and reinforcing cooking skills.

As in the case of any number of learning situations, mnemonics can be used to remember information that may be difficult to recall. In the case of sauté, an acronym was assigned to assist a user with ease of learning and storing the technique to memory. By assigning an acronym to the method, a user can readily recall the ordered procedure by which to achieve the desired result. For example, the acronym T-H-E-C-U-E can be used to illustrate that sauté comprises the steps of: applying a thin layer of oil to a pan; heating the pan/oil; evenly distributing the elements in the pan; allowing carmelization to occur; uncovering the pan/elements; and allowing evaporation to occur. In short: thin oil (T), heat pan (H), evenly distribute (E), carmelize (C), uncover (U), evaporate (E). Different acronyms and/or other mnemonics may be employed to help users learn and remember the various techniques taught. A user may thus learn to select, measure, and combine ingredients in an ordered procedure to achieve the desired result.

One example of the sauté embodiment comprises a training recipe for the preparation of a Mediterranean chicken sauté with peppers and olives. In this example, five components are introduced to illustrate the sauté technique: 1) key/main ingredient (chicken); 2) accompaniments (onion, red bell pepper, garlic); 3) deglazing liquid (white wine); 4) broth (chicken); 5) finishing ingredients (kalamata olive, fresh basil). Thus, for sauté, by following the T-H-E-C-U-E step by step methodology, the five components disclosed in this embodiment can be transformed into a preparation dish of a Mediterranean chicken sauté with peppers and olives.

As stated above, there are various techniques that make up the field of cooking. The disclosed device uses a common multiple component and multiple step integrated tool to present the concepts and knowledge useful for beginning a foundation in cooking. Those having skill in the art would recognize that any suitable cooking techniques could be taught and fall within the spirit and scope of the disclosed system and method.

In addition to guiding the user through the appropriate steps and explaining the rationale behind their inclusion and functionality, the training recipe section could instruct how to observe, for example, the occurrence of smoke, the level of doneness of an ingredient, and how to properly reserve an ingredient during the cooking process. The training recipe section can also discuss the safety issues and recap various principles generally followed by those having skill in the art of molecular gastronomy. Such tips and tools can be helpful in providing the average user with a foundation in cooking.

The training recipe section may further comprise a tutorial on how to present the completed product. A recap section can serve to reinforce the technique just viewed and/or learned. The chapter selection section of this embodiment enables the user to review the individual subsections of the training recipe section. For example, in one embodiment, a user can choose to view one or more of subsection headings entitled: Welcome, Training Recipe, Process Ingredients, Pan Selection, The Cue Method, Pan Sauce, Presentation, Recap. These subsection headings are offered by way of example only and subsections headings may change for each technique. In addition, the user could refer to a user's guide that may be associated with the particular cooking technique featured. Because the disclosed device contemplates printer and/or download capabilities, instructions, recipes, shopping lists, tables, etc. could be transferred to a medium as desired by the user, i.e., paper, computer, portable devices, ipod®, etc.

As stated above, the focus of the disclosed device on technique allows a user to understand how to cook as opposed to merely following a recipe. It is contemplated that the user can more fully understand the concepts of cooking so that the technique can be replicated using a variety of different ingredients once the foundation is laid. The disclosed device also comprises one or more reinforcement recipes for a user to select from to practice the techniques learned in the training recipe and solidify what the user has learned in the training recipe.

The reinforcement recipes are generally presented in the same format as that of the training recipe but are crafted to reinforce the construct of the disclosed system and method. In other words, the reinforcement recipes comprise similar multi-piece ensembles of components that are applied to the cooking methodology to be taught. For example, a reinforcement recipe in a sauté embodiment comprises: 1) key/main ingredient; 2) accompaniments; 3) deglazing liquid; 4) broth; 5) finishing ingredients. Application of the five component concept to the six-step methodology identified in short by T-H-E-C-U-E can help to instill the knowledge and understanding of sauté in the user so eventually other five component choice and combinations can be used to create a different sauté dish. As stated above, in some cases a user may determine from a reinforcement recipe that one or more of the ensemble components may not be necessary, however, with the multi-piece/multi-step system and method of teaching, a user will be able to adapt and accommodate any real and/or perceived variations from the foundational material.

One example of a reinforcement recipe for the sauté technique could comprise the preparation of a filet of beef with peppercorns and brandy. The ensemble of components in this example consists of beef as the key/main ingredient, red onion as the accompaniment, brandy as the deglazing liquid, and a beef broth. Finishing ingredients consist of golden raisins, heavy cream, crème fraîche and Dijon mustard. Another example of a reinforcement recipe could comprise the preparation of sautéed black mission figs with balsamico and port wine wherein the key/main ingredients are black mission figs and butter, the deglazing liquid is balsamic vinegar, the broth is port wine, and the finishing ingredients are fresh rosemary and salt. With this recipe, there are no accompaniments. Although this reinforcement recipe embodiment comprises four ensemble components, a user having an understanding of the multi-piece/multi-step foundational matter will be able to adapt with the variation. These reinforcement recipes are shown by way of example and not of limitation as other recipes may be used. In addition, recipes comprising a varying number of key/main ingredients, deglazing liquids, broths, accompaniments, and finishing ingredients/flavors are contemplated. Additionally, with different techniques a more suitable ensemble(s) of components may be utilized.

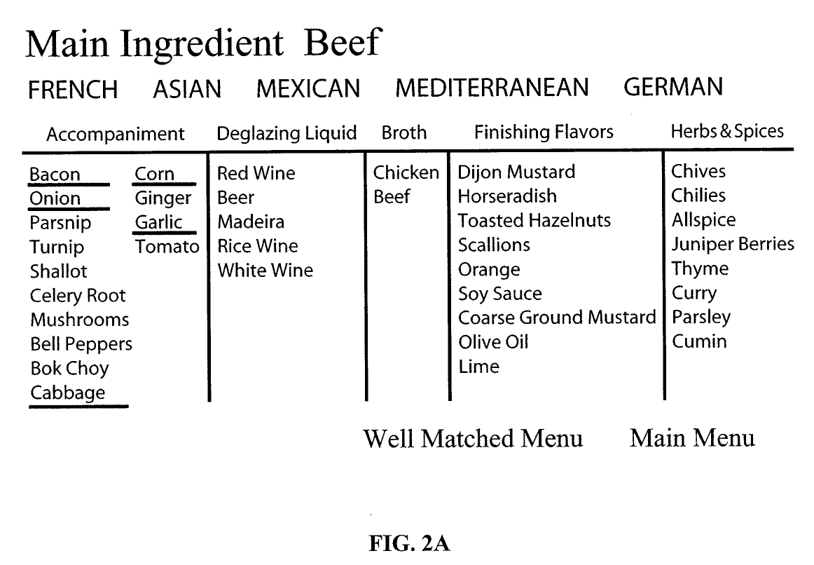

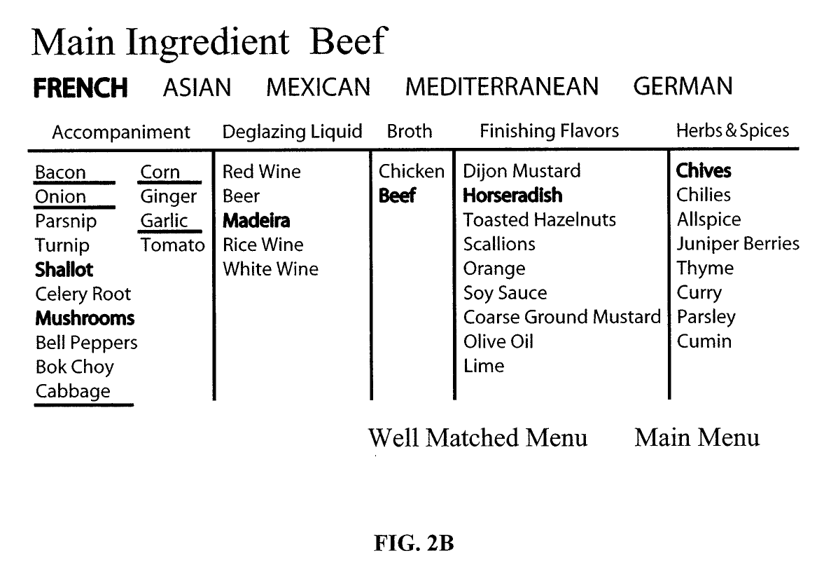

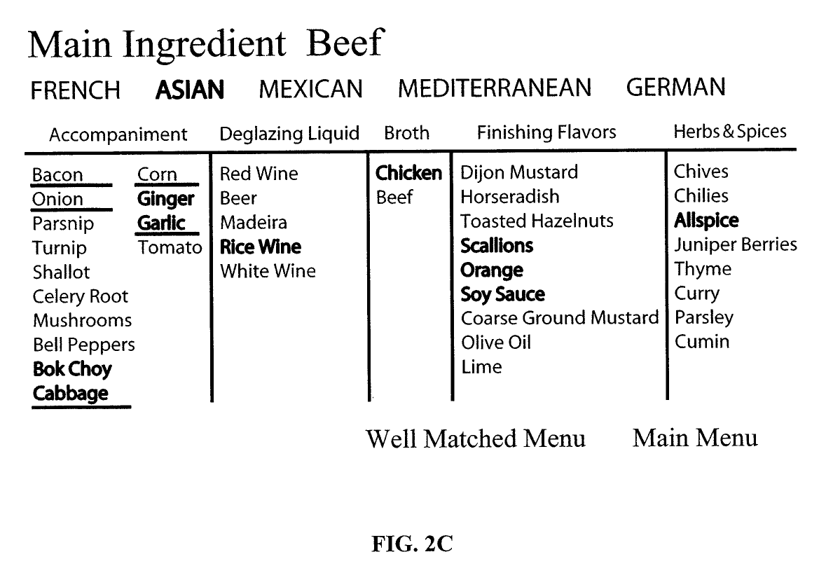

The disclosed device may also comprise a section discussing well matched ingredients. This section may highlight the experience and knowledge of seasoned chefs or others having skill in the art in bringing together ingredients that work together. These well matched ingredients may also assist in the understanding of teaching the technique and assisting the user to pick from already categorized ingredients while providing regional flair. A list of common key/main ingredients, deglazing liquids, broths, accompaniments, finishing ingredients/flavors or other desired components can be compiled such that the user can utilize guidelines and suggestions for choosing ingredients that go well together. A user may choose a key/main ingredient whereby a number of components are available for consideration. The tables comprising well matched ingredients may help to further solidify the understanding of the technique being taught. They are tools that may provide a user multiple options for dishes to prepare to help reinforce the technique being taught. See FIG. 2A for a depiction of a table displaying the above-suggested well-matched ingredients paired with beef for the sauté technique.

A user can select ingredients as dictated by a particular taste or use those as delineated by a specific cultural region. In one embodiment, ingredients commonly used in French, Asian, Mexican, Mediterranean and German cuisine can be selected. For example, if a user plans to sauté beef as a key/main ingredient and desires to explore a dish of a French nature, shallots and mushrooms (accompaniments), madeira (deglazing liquid), beef broth, and horseradish (finishing flavor) could be displayed. See FIG. 2B highlighting the well-matched ingredients for a French styled/beef sauté combination. FIG. 2C depicts a table highlighting the suggested well-matched ingredients paired with beef with an Asian flair.

A variety of regional cuisines could be incorporated with the disclosed system and method and is not limited to those discussed herein, e.g. French, Asian, Mexican, Mediterranean, and German. Those having skill in the art will recognize that different tables comprising well-matched ingredients and different cooking techniques could result in a number of combinations, regional options, etc. to reinforce the teaching of the disclosed system and method. Other such embodiments would fall within the scope of this disclosure. Additionally, different cooking techniques may be better suited for other regional cuisines.

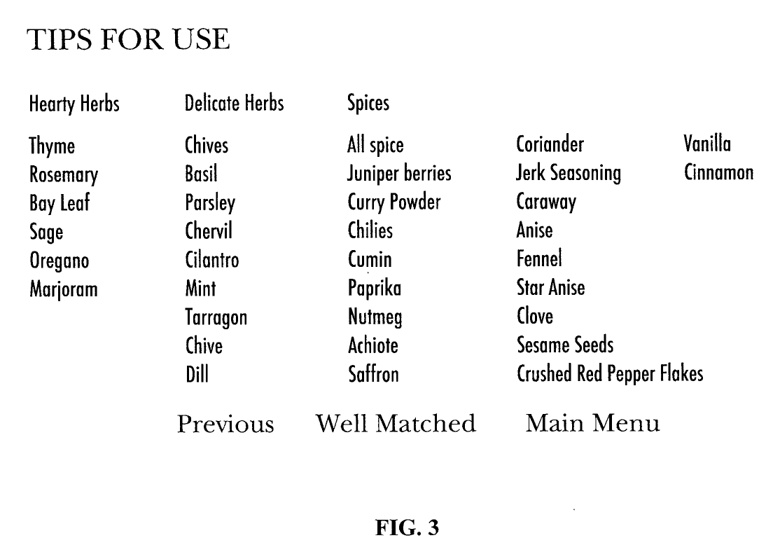

The well matched offerings could comprise additional herbs and spices. FIG. 3 provides a table displaying suggested hearty herbs, delicate herbs, and spices that may be chosen as a well-matched ingredient in conjunction with a key/main ingredient for the sauté technique. Tips and tools concerning the use of delicate and hardy herbs and spices generally could be discussed to more fully help a user understand the results of herb and spice use. For example, those having skill in the art of cooking may recognize that delicate herbs typically do not withstand cooking well and would suggest that such herbs be added with the finishing flavors. Therefore, with the above-described French beef dish, chives could be an option along with the horseradish finishing flavor. Since hearty herbs and spices would typically withstand cooking, these could be added with the accompaniments if desired. In the current French beef example, no hearty herbs or spices are suggested. As stated above, the multi-piece/multi-step system and method provides the user with the foundational basis enabling him/her to adapt to any real and/or perceived variations.

In addition to beef, common key/main ingredients in the disclosed embodiment could comprise chicken, pork, lamb, salmon, whitefish, shellfish, and dessert however, these key/main ingredients are shown by way of example and not of limitation as other key/main ingredients may be desired. With the disclosed device, these and other key/main ingredients can be combined with one or more respective accompaniments, deglazing liquids, broths, and finishing flavors using the sauté methodology to transform the ingredients into a completed product based on the user's learned understanding of the sauté technique.

To further organize information related to the well matched ingredients, components such as accompaniments can be grouped in order of longest cooking time to shortest cooking time. Those components having the longest cooking time should be used in the cooking process before those having a shorter cooking time. As shown in FIG. 2A, tomato is documented to have the shortest cooking time whereas bacon is documented to have the longest cooking time. In addition, a line delineates the accompaniments as a function of cooking time. For example, garlic is documented to have the longer cooking time over tomato. On the other hand, garlic is documented to have the shorter cooking time than corn or cabbage, etc.

The disclosed device may also comprise a section entitled “What to Drink” that could be accessed as shown in FIG. 1. The “What to Drink” section could offer an array of wine and food pairing tips and education relative to the technique covered and taught. In addition, the section could comprise an interview or tutorial with one having skill in the art of wine service to educate the user on how to choose a wine that pairs well globally with dishes prepared by the chosen technique or specifically with the recipes shown in the disclosed device, e.g., Mediterranean chicken sauté with peppers and olives for a sauté case. Not only can this section further expand and/or improve a user's understanding of the technique being taught, the tools available in this section serve to provide context and improved understanding to further reinforce the information taught in the foundational material.

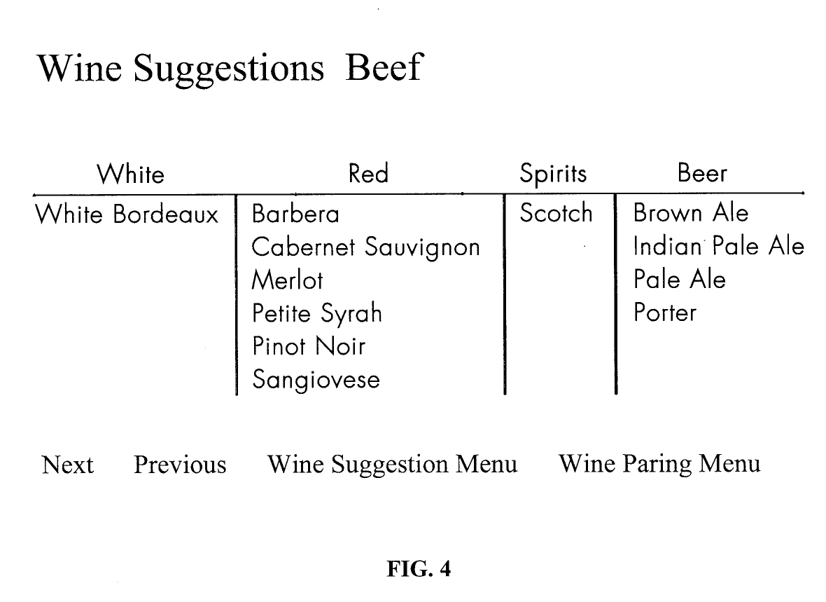

The wine pairing tutorial could comprise one or more segments discussing the choosing of wine by pairing the food region, the cooking method, the type(s) of herbs and spices chosen, and/or the main ingredient chosen. The disclosed device could also discuss use of the wine that the user simply chooses to drink. For example, an easy wine and food pairing could comprise drinking the same wine used in the cooking process. In a sauté example, the pan can be deglazed with a white, red, rose or sparkling wine. Any or all of these wines that were used as a deglazing liquid could be chosen as a well-matched pairing with the preparable dish. The categories of pairing wine and food are shown by way of example and not limitation as those having skill in the art could incorporate other recognized methods of pairing wine with food. In addition to wine, the disclosed device could suggest other beverages, including non-alcoholic beverages, to be paired globally with dishes prepared by the chosen technique or specifically with the recipes shown in the disclosed device. FIG. 4 depicts an example of a table of a sauté module suggesting beverages that could be paired with beef as a key/main ingredient.

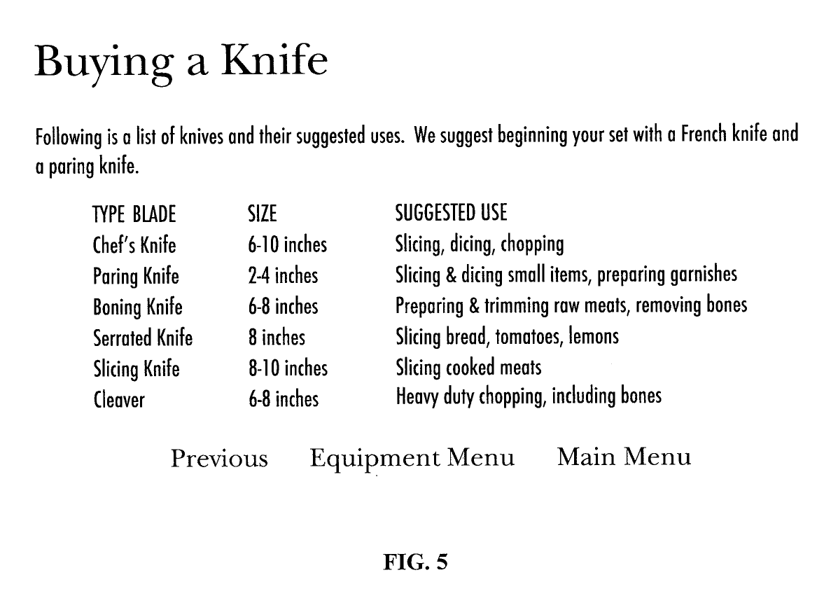

As shown in FIG. 1, the disclosed device could comprise a tutorial on equipment selection and/or care as applicable to the technique to be featured. In one embodiment, a user can learn and understand the intricacies of selecting a knife, pot, pan, etc. It is contemplated that knives could be universal to most embodiments but equipment will most likely change depending on the technique being taught. FIG. 5 provides a tabular depiction of the various differences in knife blade type, blade size, and the suggested use of each blade type. The disclosed device can enhance the equipment selection and care components by offering tutorials on how to, for example, properly self-sharpen a knife with a steel or properly choose a right-sized pan for the ingredients to be used. Such tips and tools in the form of a glossary can help to provide the user with a broader foundation in cooking. The glossary could also be accessed as a part of the user's guide associated with the particular cooking technique featured. The disclosed device could also incorporate tables such as conversion charts, abbreviations, equivalents, etc. to provide further assistance to the user.

As stated above, skill of the individual who is cooking can be a large factor that affects the preparable dish. Thus, the disclosed device seeks to increase the individual's ability and/or confidence so as to be able to vary ingredients, ambient conditions, or tools to achieve the result desired. The disclosed system utilizes the concept of integrating steps and ingredients (or pieces) with an interactive education tool where an average user can press play to learn and gain an understanding of cooking beyond mere recipe replication. The examples discussed above involve cooking related basically to sauté; however the disclosed system can be implemented for any suitable cooking technique.

Although the disclosed device and method have been described with reference to disclosed embodiments, numerous modifications and variations can be made and still the result will come within the scope of the disclosure. No limitation with respect to the specific embodiments disclosed herein is intended or should be inferred.

We claim:

1. An integrated system for teaching cooking and reinforcing cooking skills, said system comprising:
one or more training instructions for implementing a cooking technique, said one or more training instructions capable of instilling in a user a learned basis of understanding said cooking technique;
said one or more training instructions further comprising a teaching of at least one foundational component and a teaching of at least one foundational process;
a reinforcement of said learned basis of understanding, said reinforcement capable of strengthening said user's ability in said cooking technique; and
said reinforcement further comprising one or more tools capable of enabling said user to adapt said cooking technique to one or more food dishes as desired.

2. The system of claim 1, wherein said at least one foundational component further comprises an ingredient used in said cooking technique to formulate the basis of said cooking technique.

3. The system of claim 1, wherein said at least one foundational process further comprises a method step used in said cooking technique.

4. The system of claim 1, wherein said one or more reinforcement tools further comprises at least one recipe craftable specifically to reinforce in said user said one or more training instructions.

5. The system of claim 1, wherein said one or more reinforcement tools further comprises matchable ingredients that can be drawn on as desired, thereby causing a reinforcement of said one or more training instructions.

6. The system of claim 1, wherein said one or more reinforcement tools further comprises an education of equipment selection and/or care, said equipment being applicable to said cooking technique.

7. The system of claim 1, wherein said one or more reinforcement tools further comprises an education of beverage selection and/or pairing, said beverage capable of relation with said cooking technique.

8. The system of claim 1, wherein said one or more reinforcement tools further comprises a glossary, a chart, a list, or a collection of information.

9. The system of claim 1, wherein said one or more reinforcement tools further comprises a chef tip.

10. The system of claim 8, wherein said list further comprises ingredients grouped according to length of cooking time.

11. The system of claim 8, wherein said list further comprises ingredients grouped by cultural region.

12. The system of claim 1, wherein said one or more training instructions further comprises a mnemonic to enable said user to remember information related to said one or more training instructions.

13. In combination with a device capable of delivering a technique-based system for teaching cooking and reinforcing cooking skills, said system comprising:
one or more training instructions for implementing a cooking technique, said one or more training instructions capable of instilling in a user a basis of understanding of said cooking technique and a corresponding set of transferable skills;
wherein said one or more training instructions further comprise a teaching of at least one foundational component and a teaching of at least one foundational process;
a reinforcement of said learned basis of understanding, said reinforcement capable of strengthening said user's ability in said at least one foundational component and/or said at least one foundational process; and
said reinforcement further comprising one or more tools capable of enabling said user to transfer said set of skills and adapt said cooking technique to one or more food dishes as desired.

14. The system of claim 13, wherein said delivery device further comprises a DVD.

15. The system of claim 13, wherein said delivery device further comprises a DVD combinable with a touch screen apparatus.

16. The system of claim 13, wherein said delivery device further comprises a DVD combinable with a voice control apparatus.

17. The system of claim 13, wherein said delivery device enables a download of information.

18. A technique-based training system for teaching cooking and reinforcing cooking skills, said system comprising:
a training recipe comprising a plurality of components and a plurality of steps;
said training recipe capable of instilling in a user a basis of understanding a cooking technique;
each of said plurality of components representing an ingredient used in said cooking technique;
each of said plurality of steps representing a step of said cooking technique; and
one or more recipes from which said user may select to practice, said practice capable of causing a reinforcement in said user of said basis of understanding gained from said training recipe.

19. The system of claim 18 further comprising one or more tools capable of instilling said basis of understanding in said user, thereby enabling said user to cook and apply said cooking technique.

20. The system of claim 19, wherein said one or more tools further comprises recipes, tables arranging possible ingredients, guides, charts, definitions, instructions, tips, and/or pairings.

21. A method for teaching cooking skills, said method comprising:
providing a user with one or more instructions for implementing a cooking technique, said one or more instructions targeted to instill in said user a foundation of knowledge of said cooking technique;
providing said user with one or more tools capable of reinforcing said foundation of knowledge;
guiding said user through said one or more instructions to establish said foundation of knowledge in said user; and
enabling said user to utilize said one or more reinforcement tools to strengthen said foundation of knowledge.

22. The method of claim 21, wherein said one or more instructions further comprises one or more ingredients used in said cooking technique.

23. The method of claim 21, wherein said one or more instructions further comprises a methodical step used in said cooking technique.

24. The method of claim 21, wherein said one or more reinforcement tools further comprise recipes presented in a format similar to that of said training recipe, wherein a practice of said recipes can solidify said user's foundation of knowledge gained from said training recipe.

25. The method of claim 21, wherein said one or more reinforcement tools further comprises matchable ingredients that can be drawn on as desired.
